(19) United States
(12) Patent Application Publication
(10) Pub. No.: US 2004/0035887 A1
(43) Pub. Date: Feb. 26, 2004

(54) Fixing member, and a fluid dispenser including such a fixing member

(75) Inventors: Stephane Beranger, Le Neubourg (FR); Firmin Garcia, Evreux (FR)

Correspondence Address: SUGHRUE MION, PLLC, 2100 PENNSYLVANIA AVENUE, N.W., WASHINGTON, DC, 20037, US

(73) Assignee: VALOIS SAS

(21) Appl. No.: 10/461,407

(22) Filed: Jun. 16, 2003

Related U.S. Application Data
(60) Provisional application No. 60/395,347, filed on Jul. 12, 2002.

(30) Foreign Application Priority Data
Jun. 14, 2002 (FR) FR-02.07386

(51) Int. Cl. G01F 11/06

(52) U.S. Cl. 222/321.9

(57) ABSTRACT

A fixing member (1) for fixing a dispensing member (2) to a neck (30) of a receptacle (3), said fixing member comprising member-receiving means (120) serving to receive said dispensing member (2), and fixing means (10) serving to co-operate with an inside wall (31) and an abutment surface (35) of the receptacle neck, once the fixing member has reached its final position in which it is fixed to the neck, said fixing means comprising a collar (11) which extends outwards and which serves to come into abutment against the abutment surface (35) of the neck in the final position, and a skirt (10) serving to be engaged in the neck so as to come into tight-fitting contact with the inside wall (31) of the neck in the final position, said skirt (10) having a top end (101) and a bottom end (102), said fixing member being characterized in that the skirt (10) includes an elastically-deformable segment (103) that can be elastically deformed radially inwards and that is suitable for being and for remaining elastically deformed by contact with the inside wall (31) of the neck in the final position.

### CROSS REFERENCE TO RELATED APPLICATION

This application claims the benefit under 35 U.S.C. §119(e) of pending U.S. provisional patent application Serial No. 60/395,347, filed Jul. 12, 2002, and priority under 35 U.S.C. §119(a)-(d) of French patent application No. FR-02.07386, filed Jun. 14, 2002.

### TECHNICAL FIELD

The present invention relates to a fixing member and to a fluid dispenser comprising a receptacle, a dispensing member such as a pump or a valve, and a fixing member for fixing the dispensing member to the receptacle. Such dispensers are in frequent use in the fields of perfumes, of cosmetics, or indeed of pharmaceuticals, for dispensing fluids by pressing manually with a finger on a pusher.

### BACKGROUND OF THE INVENTION

The present invention is applicable, inter alia, to a type of receptacle that forms an opening or a neck defining an inside. wall that forms a reduced-aperture segment below which the wall is outwardly recessed at least locally to form an enlarged-aperture segment. However, the inside wall of the neck may also be cylindrical. As regards the fixing member, it comprises member-receiving means for receiving the body of the dispensing member, and a fixing skirt serving to be fitted by force into said opening. The skirt has an outside wall defining a segment serving to come into contact with the inside wall of the neck when the skirt is fitted fully into the neck of the receptacle.

A dispenser including a fixing member of that type is known from Document U.S. Pat. No. 3,937,366. In that document, the inside wall of the neck of the receptacle is provided with a peripheral groove in which a rib formed on the outside wall of the skirt comes to snap-fasten. That portion of the skirt which is situated immediately above the rib has a diameter smaller than the diameter of the bottom of the groove, even when the skirt is not yet fitted into the neck of the receptacle. It can be said that the outside profile of the skirt is entirely complementary to the inside profile of the neck of the receptacle. Similarly, the shape of the groove in the inside wall of the neck is exactly complementary to the shape of the rib on the skirt. Thus, there is no tight-fitting radial contact between the skirt and the inside wall of the neck, but rather the rib is merely snap-fastened into the groove in the neck. Leaktightness between the skirt and the neck is thus very difficult to achieve.

The same applies for the fixing member described in Document FR-2 792 295. That member uses a ring on which a pump or a valve is mounted. The ring also-co-operates with the inside wall of a receptacle neck that has a reduced-aperture segment below which an enlarged-aperture segment extends. The ring is provided with a skirt that serves to engage the inside of the neck. That skirt has an external radial projection serving to be received in the enlarged-aperture segment which, in that document, is in the form merely of a peripheral recess formed in the inside wall of the neck. That is a snap-fastening system consisting in engaging the external projection on the skirt in the internal recess of the neck. The skirt is only temporarily deformed, until the projection reaches the recess. Then the skirt returns to its original shape.

Above that external projection, the skirt defines a segment of smaller diameter that is received at the reduced-aperture segment formed immediately above the internal recess in the neck. However, it is not visible on the figures of that document that the outside diameter of the skirt segment situated at the reduced-aperture segment of the neck is smaller than the inside diameter of the neck at said reduced-aperture segment. It is not described in the text of that document either.

Furthermore, in the text of that document and in its claims, it is clearly defined that the fixing member is provided with snap-fastening means suitable for being received in said recess in the inside wall of the neck; in the example given, those snap-fastening means are formed by the external projection.

Moreover, it has been observed that the plastics material of fixing members made of plastic tends to creep where they are in pressed contact against the neck. In the medium term, that results in the engagement of the member in the neck loosening so that the fixing member can easily be torn off from the neck.

### SUMMARY OF THE INVENTION

An object of the present invention is to remedy the drawbacks of the prior art by defining a fixing ring that achieves both secure fixing and also excellent leaktightness, even in the long term.

To this end, the present invention provides a fixing member for fixing a dispensing member to a neck of a receptacle, said fixing member comprising member-receiving means serving to receive said dispensing member, and fixing means serving to co-operate with an inside wall and an abutment surface of the receptacle neck, once the fixing member has reached its final position in which it is fixed to the neck, said fixing means comprising a collar which extends outwards and which serves to come into abutment against the abutment surface of the neck in the final position, and a skirt serving to be engaged in the neck so as to come into tight-fitting contact with the inside wall of the neck in the final position, said skirt having a top end and a bottom end, said fixing member being characterized in that the skirt includes an elastically-deformable segment that can be elastically deformed radially inwards and that is suitable for being and for remaining elastically deformed by contact with the inside wall of the neck in the final position. This contact is pressed, tight-fitting, and advantageously leaktight contact, and it is also permanent since the deformable segment remains deformed when the ring is in the final position in the neck. It should also be noted that the fixing member of the invention is not subjected to any deformation through material displacement or creep.

This does not apply in Document U.S. Pat. No. 3,937,366, in which the skirt has a diameter that is exactly equal to the diameter of the neck, even at the groove. It does not apply either in Document FR-2 729 295 in which the ring is snap-fastened in the recess formed in the inside wall of the neck. Therefore, the rings in both of those prior art documents undergo elastic deformation that is very temporary, since it occurs only as they are being inserted into the necks, and they relax again as soon as they reach their final snap-fastened positions. Those rings do not remain permanently in an elastically deformed state.

Advantageously, the top end of the skirt is substantially non-deformable. Symmetrically, the bottom end of the skirt may be substantially non-deformable. In which case, the deformable segment is situated between the non-deformable top end and the non-deformable bottom end. The elastically-deformable segment may then be in the form of a flexible band held firmly at its two rigid ends.

Advantageously, the bottom end forms a contact surface suitable for coming into abutment against the dispensing member.

According to another characteristic of the invention, the deformable segment internally defines an annular setback at which the deformable segment remains out of contact with the dispensing member so that it can be deformed inwards without coming into contact with the dispensing member. Advantageously, the setback is situated above the bottom end of the skirt that defines a contact surface which is advantageously leaktight and which is suitable for coming into contact against the dispensing member. Preferably, the setback contains a flexible elastic material suitable for being compressed radially inwards by the deformable segment, advantageously against the dispensing member. In which case the flexible material is mounted in or overmolded in the setback. It is preferably in contact with the skirt and with the body of the dispensing member without occupying the entire volume of the setback.

In another feature, the deformable segment is externally cylindrical. In a variant, the deformable segment is provided with at least one outwardly-projecting profile, which may advantageously be suitable for being received in a recess formed in the inside wall of the receptacle neck.

The invention also provides a fluid dispenser comprising a receptacle forming a neck, a dispensing member, and a fixing member. Advantageously, the neck defines an inside wall provided with a recess serving to receive the deformable segment of the skirt.

In another feature, the skirt is spaced apart from the body by an intermediate space.

### BRIEF DESCRIPTION OF THE DRAWINGS

The invention is described more fully below with reference to the accompanying drawings, which give three embodiments of the invention by way of non-limiting example.

In the figures:

FIG. 1 is a diagrammatic section view through a dispensing member as equipped with a fixing member of the invention, ready to be inserted into neck of a receptacle;

FIG. 2 is a view corresponding to the FIG. 1 view, with the fixing member engaged in the receptacle neck;

FIG. 3 is a view similar to the FIG. 1 view, but showing a second embodiment;

FIG. 4 is a view similar to the FIG. 2 view, but showing the second embodiment;

FIG. 5 is a view similar to the FIG. 1 view, but showing a third embodiment of the invention; and

FIG. 6 is a view similar to the FIG. 2 view, but showing the third embodiment of the invention.

### DETAILED DESCRIPTION OF THE INVENTION

In the figures, only the top portion of a fluid dispenser of the invention is shown, so that the receptacle is represented merely by its neck. However, the dispenser of the invention comprises three component parts, namely a receptacle 3, a dispensing member 2, and a fixing member 1.

In this example, the receptacle 3 is provided with a neck 30 which projects upwards from the body of the receptacle (not shown) whose function is to contain fluid. The neck defines an opening which makes it possible to communicate with the inside of the receptacle. However, it is possible to imagine other embodiments for the receptacle, in which there is no projecting neck, but rather merely an opening in the body of the receptacle. With reference to the figures, it is possible, for example, to imagine that the end portion of the neck 30 can be situated directly at the level of the shoulder 37. It can then be said that the opening has no neck. A projecting neck is thus not an essential element of the present invention.

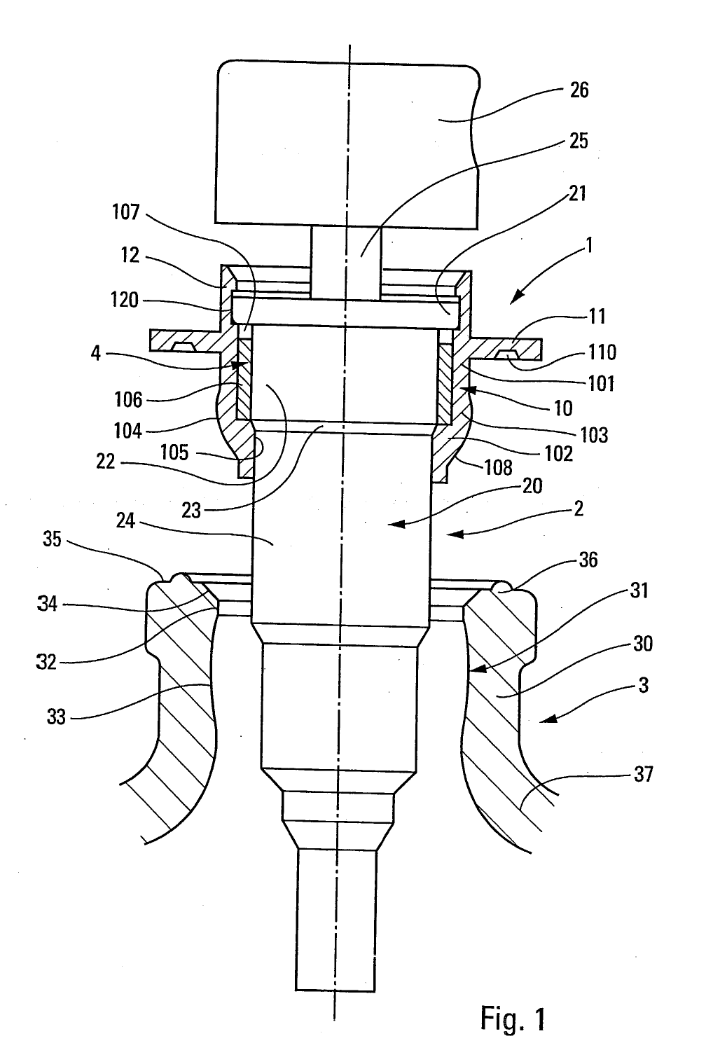

In FIGS. 1 to 4, the neck 30 has an inside wall 31 that is not cylindrical, but rather that has a reduced-aperture segment 32 below which an enlarged-aperture segment 33 is defined. The reduced-aperture segment is situated in the vicinity of the outlet of the neck which, at that place, forms a top end 35 of annular shape. Advantageously, the reduced-aperture segment 32 is connected to the top end 35 via a frustoconical or flared leading segment 34. The reduced-aperture segment 32 may be substantially cylindrical. The enlarged-aperture segment 14 may also be substantially cylindrical. It is possible to imagine that the enlarged-aperture segment 33 may be in the form of a peripheral recess that extends over a certain height of the neck and that is extended downwards via another segment of diameter substantially equal to the diameter of the reduced-aperture segment. It is also possible to imagine that the enlarged-aperture segment may be in the form of a plurality of recesses distributed around the inside periphery of the neck. In other words, regardless of the shape of the enlarged-aperture segment, it must, at least locally, have an inside diameter that is greater than the inside diameter of the reduced-aperture segment. In the embodiment shown in the figures, the reduced-aperture segment is cylindrical, and the enlarged-aperture segment 14 extends downwards from the reduced-aperture segment 13 by starting with a flared transition segment. It can be considered that the flared transition segment is part of the enlarged-aperture segment 33 because its diameter is smaller than the diameter of the reduced-aperture segment 32. The enlarged-aperture segment 33 is then extended downwards to connect to the shoulder 37. Naturally, it is possible to imagine that there is no transition segment, and that the enlarged-aperture segment is connected to the reduced-aperture segment via a shoulder having a sharp edge. In which case, it is not necessary to have a neck that extends over a certain height, and such an opening with a reduced-aperture segment and an enlarged-aperture segment can be implemented at the shoulder 37.

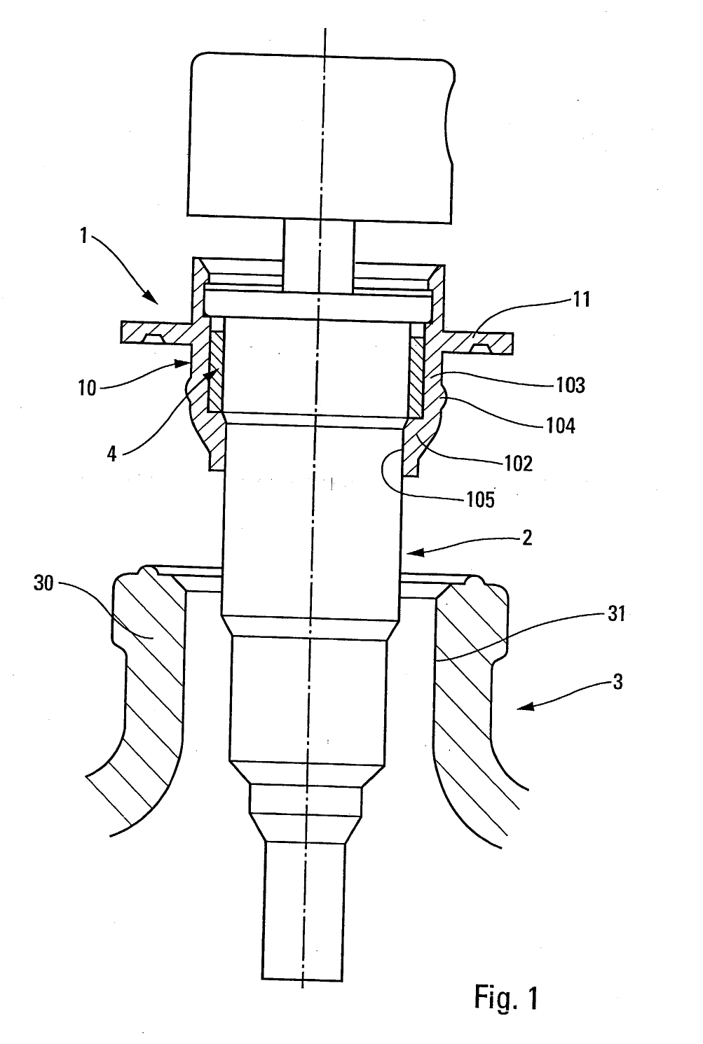

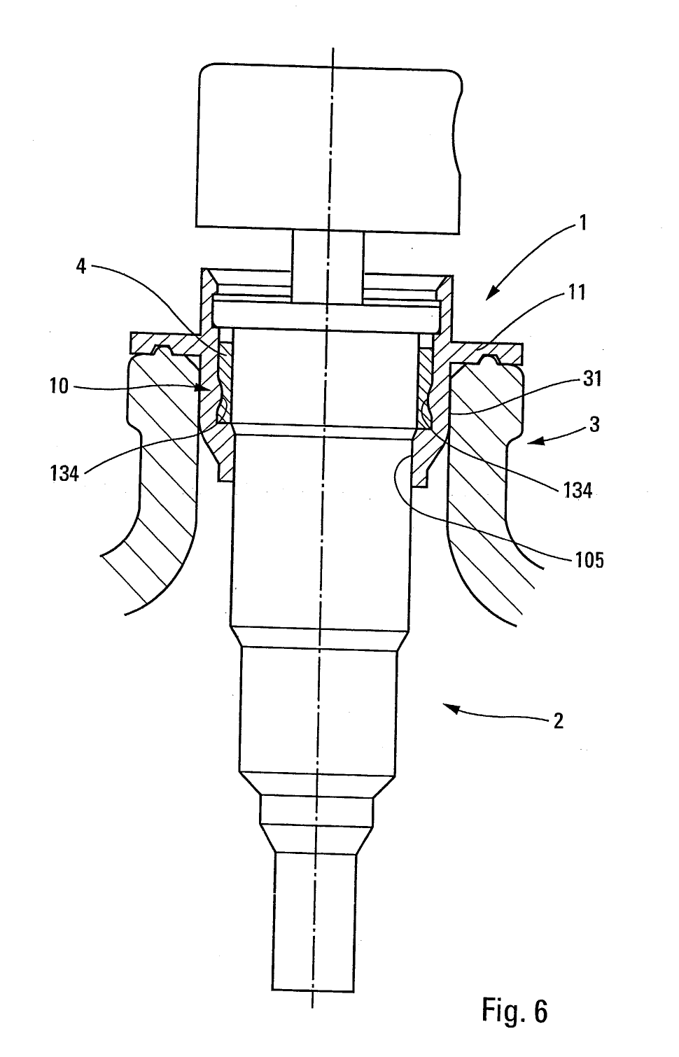

In contrast, in the third embodiment shown in FIGS. 5 to 6, the neck has a cylindrical inside wall, at least over the portion of its height that serves to co-operate with the fixing member.

The dispensing member 2, which, in this example, is a pump or a valve, comprises a body 20 defining an outwardly-projecting flange 21 at its top end. Below the flange, the pump body defines a body portion 22 below which a second body portion 24 of smaller diameter is connected, so that, between the two body portions 22 and 24, there is a transition 23 in the form of a frustoconical step, as can be seen more clearly in the figures. Below the second body portion 24, the body 20 defines another body portion that is of still smaller diameter It can be said that the body 20 is stepped four times because it comprises four body portions of decreasing diameters starting from the flange 21. This is merely a particular embodiment, and, naturally, it is possible to imagine a body 20 that is exactly cylindrical. Conventionally, the pump 2 is provided with an actuating rod 25 which is mounted to slide in the body 20. The actuating rod 25 underlies a pusher 26 that defines a dispensing orifice. To actuate the pump 2, it suffices merely to press on the pusher to push the rod into the body, thereby causing a metered quantity or “dose” of fluid to be delivered to the dispensing orifice. This is an entirely conventional pump or valve.

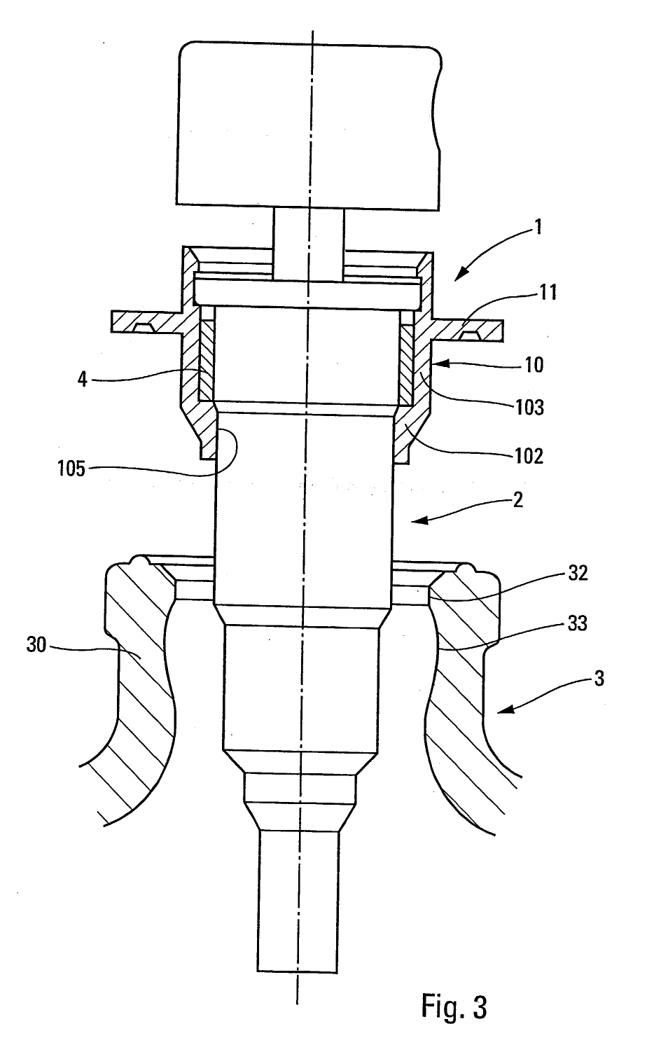

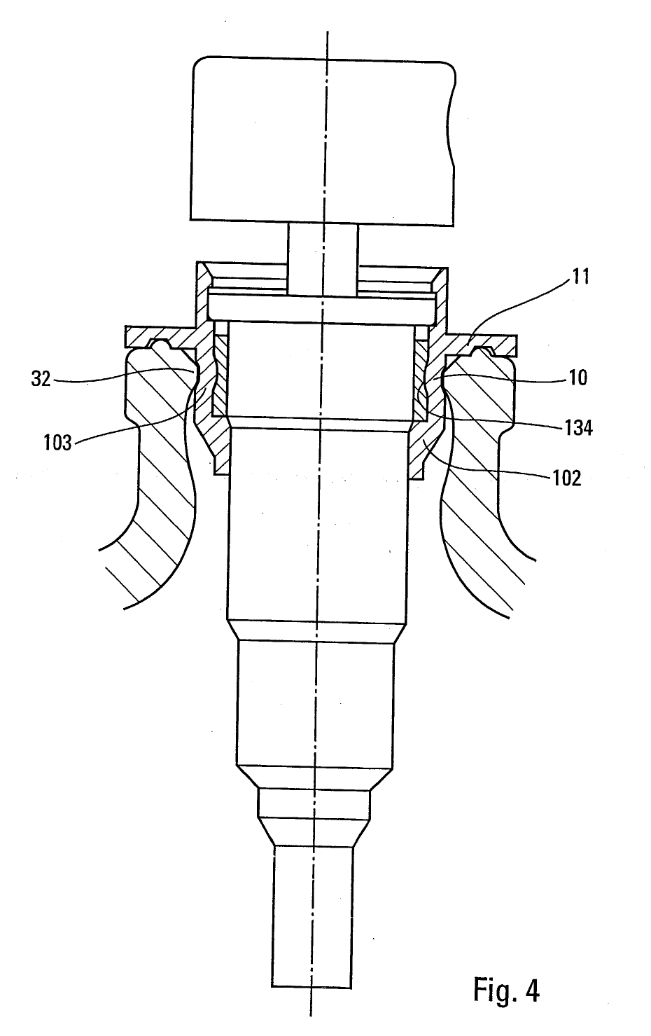

The purpose of the fixing member 1 is to hold the dispensing member 2 and to fix it in the opening of the neck 30. The fixing member is in the form of a fixing ring provided with member-receiving means in the form of a sleeve 12 internally defining a snap-fastening recess 120 in which the flange 21 of the pump is received. The fixing ring 1 is also provided with a fixing skirt 10 serving to be inserted into the neck. The skirt 10 extends substantially in alignment with the sleeve 12. It can be observed that the skirt 10 is out of contact with the body at the second body portion 22, but rather that an intermediate space or setback 106 remains that prevents any contact or interference between the skirt 10 and the body 20. This possible because the body is stepped, but it is also possible to obtain the same intermediate space or setback by stepping the skirt 10 relative to the sleeve 12. The skirt has an outside wall that is substantially cylindrical as in the embodiment shown in FIGS. 3 and 4, or that has a shaped profile as in the embodiments shown in FIGS. 1, 2, 5, and 6. At its bottom end, the skirt may be formed with a bevel 108 which makes it possible to facilitate inserting the skirt into the opening of the neck.

The skirt 10 thus extends substantially in alignment with the sleeve 12 and spaced apart from the body 20 at its top segment 22 so as to form an intermediate space or setback 106 there. The flange 21 of the body 20 is snap-fastened inside the sleeve 12, thereby imparting a certain amount of rigidity or non-deformability to it. Where the skirt 10 connects to the sleeve 12, i.e. where they meet, a collar 11 extends radially outwards. In its bottom face, said collar 11 is provided with a groove 110 serving to receive a sealing bead 36 formed on the top end 35 of the neck 30. The radial collar 11 also imparts non-deformability to the ring so that the top end 101 of the skirt is substantially non-deformable. In addition, the skirt 10 defines a bottom end 102 which is also substantially non-deformable. This non-deformability is procured by the fact that the bottom end 102 defines a contact surface 105 suitable for coming into bearing contact against the body 20, e.g. at the frustoconical transition segment 23 and at the segment 24. It should be noted that the body 20 is already held very stably inside the fixing body by means of the flange 21 being snap-fastened in the snap-fastening recess 120 formed by the sleeve 12. However, the contact surface 105 further participates in the stability of the body 20 in the fixing member, firstly because it clamps the segment 24, and secondly because it forms an abutment against the frustoconical transition segment 23. The top and bottom ends 101 and 102 of the skirt are thus substantially non-deformable.

In the invention, the skirt 10 further defines an elastically-deformable segment 103 which extends in the is example between the non-deformable ends 101 and 102. In this example, this elastically-deformable segment 103 is in the form of a substantially cylindrical segment whose two ends 101 and 102 are substantially non-deformable. It should be noted that this elastic deformability is imparted by the fact that the ends are substantially non-deformable, so that the elastically-deformable segment can be said to be held or “tensioned” between the two ends.

Furthermore, the elastically-deformable segment 103 is situated where the intermediate space or setback 106 is formed that separates the skirt 10 from the pump body 20 at the top segment 22. To this end, it can be said that the setback 106 is formed by the inside wall of the skirt 10, by the non-deformable bottom end 102 of the skirt 10, by the top segment 22 of the body 20, and by the collar 21 as snap-fastened in the sleeve 12. The setback 106, which is largely defined by the skirt 10, enables the elastically-deformable segment 103 to be deformed radially inwards without coming into contact with the body 20. It is thus possible to say that the setback 106 serves as clearance to enable the elastically-deformable segment 103 to be deformed inwards.

In the invention, the setback 106 contains a flexible elastic material 4 that preferably does not tend to creep very much. In other words, the material 4 must have elasticity that remains permanent even after a long period of time. The piece of flexible material 4 partially fills the setback 106 so as to leave a free or empty portion 107. Thus, the material 4 can expand into the empty portion 107 when the elastically-deformable segment 103 is stressed radially inwards, thereby reducing the volume of the setback 106. The material 4 is preferably disposed such as to be in contact both with the inside wall of the skirt and with the outside wall of the top segment 22 of the pump body 20. Thus, it can act as a resilient return spring making it possible to impart elastic deformability to the elastically-deformable segment 103 if it loses it due to material creep. It is quite possible, within the ambit of the invention, to omit the piece of flexible elastic material 4 disposed inside the setback 106, in the event that the plastics material of which the skirt 10 is made has permanent or lasting elastic deformability, i.e. if it does not tend to creep as most plastics materials often do. When the plastics material of which the skirt 10 is made tends to creep, it is preferable to fill the setback 106 partially with such a flexible elastic material 4. Such a material makes it possible to push the skirt 10 continuously against the inside wall of the neck by reaction on the pump body 20. The piece of flexible elastic material 4 therefore takes over from the elastically-deformable segment 103 whenever necessary.

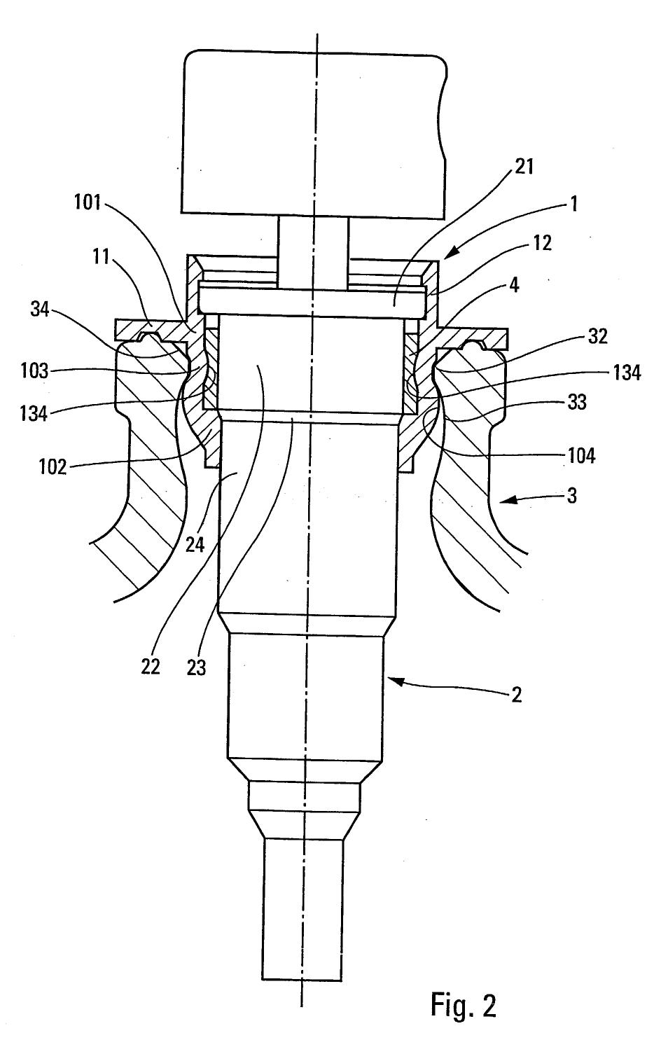

Reference is made more particularly below to FIGS. 1 and 2 to explain the first embodiment in detail. In this embodiment, the neck 30 is formed with a reduced-aperture segment 32 which is extended downwards by an enlarged-aperture segment 33. On its outside wall, the skirt 10 is provided with a projecting annular bulge 104 that is situated on the bottom portion of the elastically-deformable segment 103. Once fully engaged in the neck, as shown in FIG. 2, the fixing member 1 is positioned such that its collar 11 comes into abutment against the top end 35 of the neck with the bead 36 in leaktight engagement in the groove 110. In addition, the elastically-deformable segment 103 is situated at the reduced-aperture segment 32. Since the inside diameter of the reduced-aperture segment 32 is smaller than the outside diameter of the elastically-deformable segment 103, prior to fitting the fixing member in the neck, the reduced-aperture segment 32 causes the elastically-deformable segment 103 to deform inwards to form a projection 134 that reduces the inside volume of the setback 106 in which the piece of flexible material 4 may be disposed. The elastically-deformable segment 103 is thus deformed around the reduced-aperture segment 32 so that the top portion of the elastically-deformable segment extends slightly over the frustoconical segment 34 of the neck, and the bottom portion of the elastically-deformable segment, which portion is provided with the bulge 104, comes to be received in the enlarged-aperture segment 33, thereby participating in or improving the fixing and the locking of the fixing member inside the neck. It can thus be said that the bulge 104 is “snap-fastened” in the enlarged-aperture segment 103, while the elastically-deformable segment is pressed against the reduced-aperture segment 32: this pressing action may advantageously be supplemented by the presence of a piece of elastic material 4 in the setback 106.

In the second embodiment shown in FIGS. 3 and 4, the elastically-deformable segment 103 has an outside wall that is substantially or entirely cylindrical. In addition, the neck is similar or identical to the neck in the embodiment shown in FIGS. 1 and 2, i.e. it has a reduced-aperture segment 32 that is extended downwards by an enlarged-aperture segment 33. Once engaged in the neck, as shown in FIG. 4, the skirt 10 is deformed in the same way as in FIG. 2. The only difference between these two embodiments is that the skirt 10 in FIGS. 3 and 4 does not have a projecting bulge 104 formed on the bottom portion of the elastically-deformable segment 103. The result is almost identical except that the bottom portion of the elastically-deformable segment 103 does not penetrate as far into the enlarged-aperture segment 33 of the neck. This shows that the skirt 10 may be cylindrical or shaped with profiles that project to various extents.

The third embodiment shown in FIGS. 5 and 6 is substantially identical as regards the fixina member as the embodiment shown in FIGS. 1 and 2 in that the skirt 10 is provided with a projecting bulge 104 formed on the elastically-deformable segment 103. However, the inside wall 31 of the neck 30 is, in this embodiment, entirely cylindrical. Once engaged in the neck, the skirt 10 is deformed inwards at its elastically-deformable segment 103 to form a projection 134 that penetrates into the setback 106, thereby deforming the piece of flexible material 4. As regards the outside wall of the skirt 10, it has a configuration identical to the configuration of the cylindrical inside wall 31 of the neck 30.

The spirit of the invention lies in the fact that the skirt engaged in the neck is elastically deformable (and not deformed by displacement or creep of material), this elastic deformability enabling the skirt to exert a pressure that remains constant over time against the inside wall of the neck. The skirt may be assisted in this by a piece of durable flexible elastic material placed inside the skirt.

1/ A fixing member (1) for fixing a dispensing member (2) to a neck (30) of a receptacle (3), said fixing member comprising member-receiving means (120) serving to receive said dispensing member (2), and fixing means (10) serving to co-operate with an inside wall (31) and an abutment surface (35) of the receptacle neck, once the fixing member has reached its final position in which it is fixed to the neck, said fixing means comprising a collar (11) which extends outwards and which serves to come into abutment against the abutment surface (35) of the neck in the final position, and a skirt (10) serving to be engaged in the neck so as to come into tight-fitting contact with the inside wall (31) of the neck in the final position, said skirt (10) having a top end (101) and a bottom end (102), said fixing member being characterized in that the skirt (10) includes an elastically-deformable segment (103) that can be elastically deformed radially inwards and that is suitable for being and for remaining elastically deformed by contact with the inside wall (31) of the neck in the final position.

2/ A fixing member according to claim 1, in which the top end (101) of the skirt (10) is substantially non-deformable, the bottom end (102) of the skirt (10) being also substantially non-deformable, the deformable segment (103) being situated between the non-deformable top end (101) and the non-deformable bottom end (102).

3/ A fixing member according to claim 1, in which the bottom end (102) forms a contact surface (105) suitable for coming into abutment against the dispensing member (2).

4/ A fixing member according to claim 1, in which the deformable segment (103) internally defines an annular setback (106) at which the deformable segment remains out of contact with the dispensing member (2) so that it can be deformed inwards without coming into contact with the dispensing member.

5/ A fixing member according to claim 4, in which the setback (106) is situated above the bottom end (102) of the skirt that defines a contact surface (105) which is advantageously leaktight and which is suitable for coming into contact against the dispensing member (2).

6/ A fixing member according to claim 4, in which the setback (106) contains a flexible elastic material (4) suitable for being compressed radially inwards by the deformable segment, advantageously against the dispensing member (2).

7/ A fixing member according to claim 1, in which the deformable segment (103) is externally cylindrical.

8/ A fixing member according to claims 1, in which the deformable segment (103) is provided with at least one outwardly-projecting profile (104).

9/ A fluid dispenser comprising a receptacle (3) forming a neck (30), a dispensing member (2), and a fixing member (1) for fixing a dispensing member (2) to a neck (30) of a receptacle (3), said fixing member comprising member-receiving means (120) serving to receive said dispensing member (2), and fixing means (10) serving to co-operate with an inside wall (31) and an abutment surface (35) of the receptacle neck, once the fixing member has reached its final position in which it is fixed to the neck, said fixing means comprising a collar (11) which extends outwards and which serves to come into abutment against the abutment surface (35) of the neck in the final position, and a skirt (10) serving to be engaged in the neck so as to come into tight-fitting contact with the inside wall (31) of the neck in the final position, said skirt (10) having a top end (101) and a bottom end (102), said fixing member being characterized in that the skirt (10) includes an elastically-deformable segment (103) that can be elastically deformed radially inwards and that is suitable for being and for remaining elastically deformed by contact with the inside wall (31) of the neck in the final position.

10/ A dispenser according to claim 9, in which the neck (30) defines an inside wall (31) provided with a recess (33) serving to receive the deformable segment (103) of the skirt.

11/ A dispenser according to claim 10, in which the segment (103) is provided with an outwardly-projecting profile (104) received in the recess (33).

12/ A dispenser according to claim 11, in which the inside wall (31) comprises a reduced-aperture segment (32) located above the recess (33), the deformable segment (103) being deformed against the reduced-aperture segment with the profiled received in the recess.

13/ A dispenser according to claim 9, in which the skirt (10) is spaced apart from the body (20) by a setback (106).
